(19) United States
(12) Patent Application Publication
(10) Pub. No.: US 2004/0263159 A1
(43) Pub. Date: Dec. 30, 2004

(54) Method of determining the movement of a shaft

(76) Inventors: Michel Herbert, Chanu (FR); Francois Breynaert, Caen (FR)

Correspondence Address: CARLSON, GASKEY & OLDS, P.C., 400 WEST MAPLE ROAD, SUITE 350, BIRMINGHAM, MI, 48009, US

(21) Appl. No.: 10/496,472

(22) PCT Filed: Sep. 12, 2003
(86) PCT No.: PCT/FR03/02700

(30) Foreign Application Priority Data
Sep. 13, 2002 (FR) 02/11369

(51) Int. Cl. G01B 7/30

(52) U.S. Cl. 324/207.25

(57) ABSTRACT

A device for determining the movement of a drive shaft includes the drive shaft, which is rotated around an axis and that can move along the length of the axis, a multi-pole magnet and a sensor. The sensor or the magnet is rotated by the drive shaft. The magnet presents the sensor with North and South poles that alternate according to the relative angular position the sensor and the magnet along the axis. The poles are made from a magnetizable material. The movement of the drive shaft along the axis can be detected according to the detected alternating poles. The invention also relates to a geared motor, a window regulator and a magnet.

The invention relates to a device for determining movement of a drive shaft. It also relates to a magnet of the device, a motor and speed reduction gear fitted with such a device, and to a vehicle window regulator incorporating the motor and speed reduction gear.

Automobile vehicles are increasingly equipped with electrically operated equipment. Vehicles can typically include sliding roofs, window glass regulators, or rear view mirrors driven by electric motors. The problem arises of determining the drive torque of such motors.

German patent application 19,919,099 discloses a system for measuring axial movement of a drive shaft. A sensor detects movements of a magnetised ring integral with the shaft; the disadvantage of this system is that the ring carrying the magnets on its periphery is complex to produce and consequently expensive.

German patent application 19,854,038 relates to a system allowing the rotational movement of a drive device such as a window regulator motor and reduction gear to be determined. The device includes a stationary sensor inside a casing in which a drive shaft is driven in rotation. The drive shaft is mounted in the casing with axial play. A magnet is driven in rotation by the drive shaft. According to one embodiment, of the magnet has a frustoconical shape, which opens out towards one end of the drive shaft. The magnet delivers magnetic flux of varying strength towards a sensor depending on the relative axial position of the magnet and sensor. The magnetic flux produces an induced current. Variations in magnetic flux lead to variable induced currents, and measuring the current allows the movement of the drive shaft inside the casing to be determined along with the output torque of the drive motor. Additionally, the torque is read by analog means.

The disadvantage of such a device is that of complexity since the output torque is determined by the current induced from the magnetic flux. This consequently increases the time needed to determine torque.

There is consequently a need for a simpler device which can determine the output torque of a drive motor more rapidly.

The invention consequently provides a device for determining the movement of a shaft, comprising:

a drive shaft driven in rotation about an axis and movable along said axis,

a multi-pole magnet;

a sensor, the sensor or magnet being driven by the drive shaft; the magnet presenting to the sensor an alternation of North and South poles as a function of the relative position, both angular and along said axis, of the sensor and magnet.

In one embodiment, the poles have facing edges which are inclined with respect to the axis of rotation of the drive shaft.

According to another embodiment, the magnet is a ring driven in rotation by the drive shaft, the ring having, in its thickness, poles which extend radially.

Advantageously, the poles have a triangular cross section.

Preferably, the sensor is a Hall effect sensor.

In one embodiment, the device further comprises a casing in which the drive shaft is driven in rotation about said axis and is movable along said axis, the sensor being in the casing.

There is also provided a motor and speed reduction gear that includes the above device.

Advantageously, the motor and speed reduction gear further comprises an output shaft driven by the drive shaft.

The invention further provides a window glass regulator comprising a cable winding drum and the motor and speed reduction gear described above, the output shaft driving the cable winding drum.

There is also provides a magnet having a plurality of poles, the poles alternating during rotation about an axis of symmetry as a function of position along said axis of said magnet and with respect to a plane perpendicular to the axis.

Advantageously, the poles have convergent edges.

preferably, the magnet comprises

two coaxial flanges,

on each flange, poles which extend towards the other flange, each pole of a flange being interleaved between two poles of the other flange.

In one embodiment, the poles are of magnetizable material.

According to another embodiment, the flanges are of magnetic material.

Advantageously, the flanges, and their respective poles, are separable from each other.

Further characteristics and advantages of the invention will become more clear from the description which follows of some embodiments provided solely by way of example and with reference to the attached drawings.

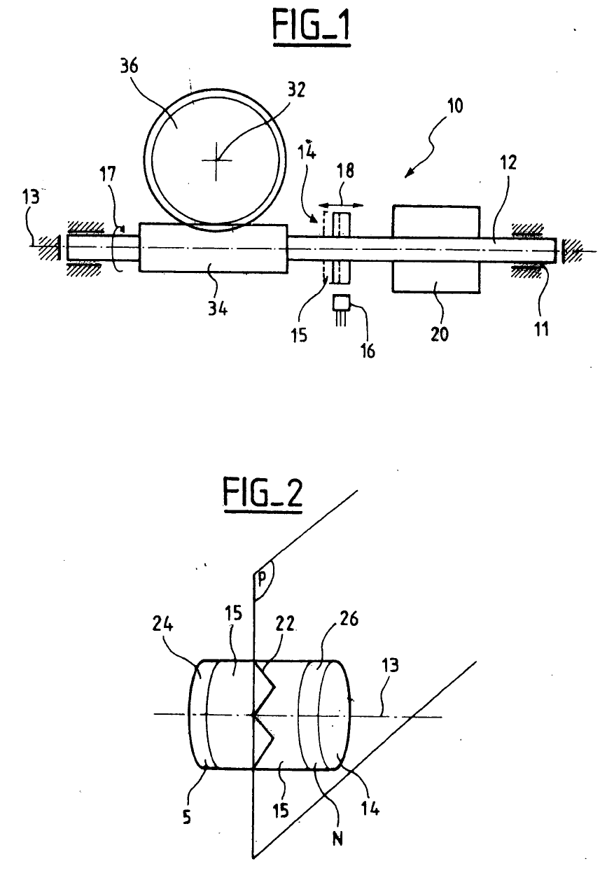

FIG. 1 shows the device of the invention;

FIG. 2 is a perspective view of the magnet;

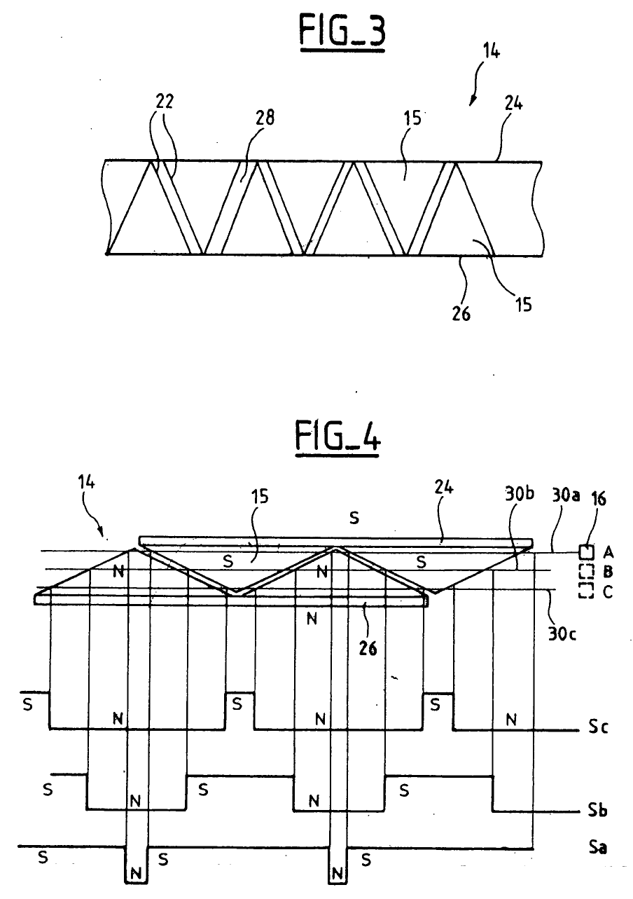

FIG. 3 is a side view of the magnet;

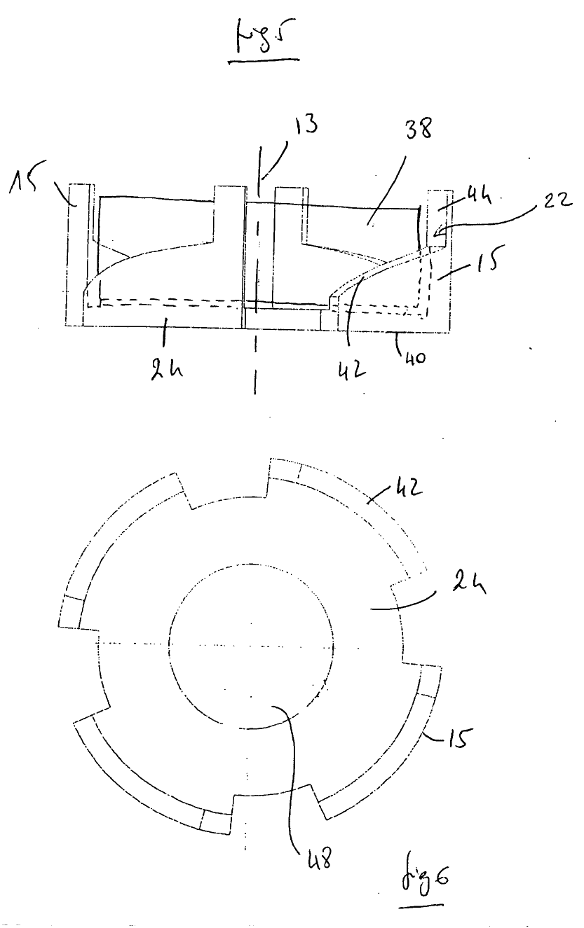

FIG. 4 is a graph showing detection of magnet pole alternation;

FIG. 5 shows another embodiment of magnet 14;

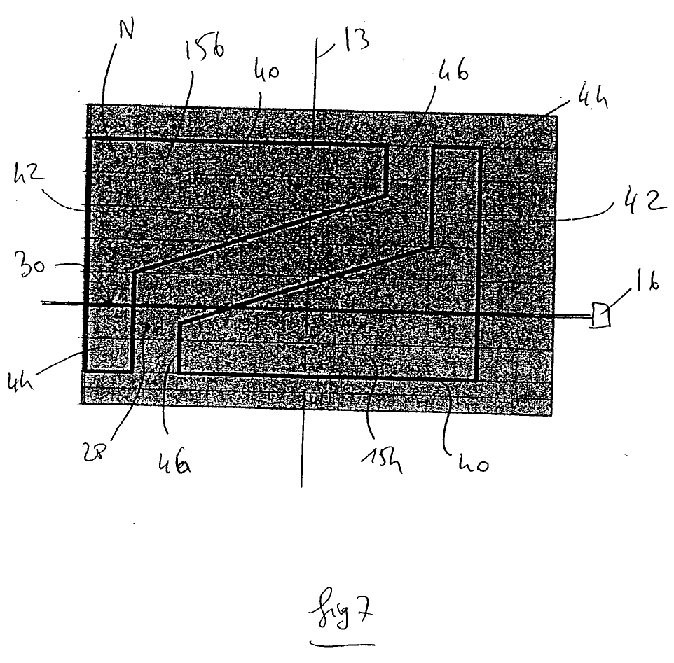

FIG. 6 is a top view of FIG. 5;

FIG. 7 shows detail of the magnet 14.

The device comprises a drive shaft movable about and along an axis and, driven by the shaft, a magnet or a sensor. The magnet presents to the sensor alternating North and south poles depending on the relative position, both angular and along the axis, of the sensor and magnet. Depending on the alternation of poles detected by the sensor, the movement and position of the shaft along the axis can be determined. Knowing the position of the shaft allows the output torque of an output shaft driven by the drive shaft to be determined.

FIG. 1 illustrates the device 10 of the invention. Device 10 comprises a drive shaft 12 driven in rotation in the direction of arrow 17 and axis 13. The drive shaft can also move along axis 13 in the direction of arrow 18. Device 10 also comprises a magnet 14 with multiple poles 15 and a sensor 16. Sensor 16 or magnet 14 is driven by drive shaft 12. FIG. 1, which is not limiting, shows the magnet 14 mounted on, and driven by, drive shaft 12. When one or the other of magnet 14 or sensor 16 is driven by drive shaft 12, the magnet 14 presents the sensor 16 with an alternation of North and south poles depending on the relative position, both angular and along axis 13, of the sensor 16 and magnet 14. Magnet 14 presents to sensor 16 an alternation of poles 15 which is specific to the relative position of magnet 14 and sensor 16.

Device 10 can further comprise a casing 11 inside which a drive shaft 12 is driven in rotation about axis 13 and is movable along this axis 13. Drive shaft 12 is for example driven in rotation of by an electric motor 20. Preferably, the electric motor can rotate in both directions. Drive shaft 12 can move along axis 13 in the direction of arrow 18 in the sense that drive shaft 12 is mounted in the casing with some assembly play. This play allows some shifting of drive shaft 12 along axis 13 when the shaft is driven by electric motor 20. The position along axis 13 of shaft 12 can be determined by detecting the alternation of magnet poles 15.

Sensor 16 allows the poles which magnet 14 presents to it to be detected. The sensor allows determination of which pole 15 is presented to it by magnet 14. Sensor 16 allows a change of pole 15 presented to sensor 16 to be determined. For example, sensor 16 is a Hall effect sensor. In the example of FIG. 1, sensor 16 is inside the casing 11. As sensor 16 is stationary inside the casing 11, this makes it easier to connect sensor 16 to a signal processing unit for the sensor.

Magnet 14 has multiple poles. In the example of FIG. 1, magnet 14 is driven by the shaft 12. The dashed lines show another position of the magnet when shaft 12 shifts along axis 13. FIG. 2 is a perspective view of magnet 14. Magnet 14 can be a ring driven in rotation by the drive shaft, the ring having in its thickness, poles which extend radially. This makes it easy to mount the magnet on shaft 12. The magnet is for example 5 mm thick. Magnet 14 has an axis of symmetry 13 about which the shape of the magnet in rotation is invariant. The axis of symmetry of the ring and of the axis of rotation of drive shaft 12 can advantageously be the same. Magnet 14 has a plurality of poles 15. The poles alternate during rotation about axis of symmetry 13 at a plane P perpendicular to axis 13, as a function of position along the axis 13 of magnet 14. Depending on the position along axis 13 of the magnet and during rotation around this axis, the alternation of the poles varies with respect to plane P. The poles 15 have converging edges 22. Thus, the boundary between two consecutive poles is inclined with respect to axis 13, and consequently with respect to movement along axis 13.

According to one embodiment, magnet 14 has two flanges 24, 26 coaxial with axis 13. On each flange, the poles 15 extend towards the other flange, each pole 15 of one flange being interleaved between two poles 15 of the other flange. As the poles have inclined edges 22, the poles 15 form a toothing on the flanges 24,26.

Preferably, the flanges 24, 26 provided with their respective poles are separable from each other. This makes a magnet easier to produce, each of the flanges and their respective poles being able to be produced separately and then assembled to the other flange. The flanges 24,26 are for example of magnetic material such as steel or soft iron and the poles of magnetizable material such as steel or soft iron. In this way, the magnetised flanges which are more fragile are readily manufactured while the poles, which are more difficult to tool, are made up of a more rigid material. The poles are fixed onto the flanges. The flanges are each of a different polarity, and the poles of a magnetizable material, adopt the nature of the polarisation of the respective flange. On FIG. 2, flange 24 is polarized South; the corresponding poles are South poles. Flange 26 and respective poles 15 are polarized North.

Alternatively, the poles 15 and flanges 24, 26 are of magnetizable material such as steel or soft iron. Thus, these parts are produced from a more rigid material and tooling of the parts is easier. FIG. 3 is a side view of magnet 14. The poles 15 are contiguous. The poles 15 have inclined facing edges 22 sloping with respect to axis 13. The poles 15 have for example a triangular cross section. This allows them to readily be interleaved with the poles of the other flange, the peak of a pole of one flange being interleaved between the base of two poles of the other flange. The angle at the peak depends on the number of poles and the shape of the polar mass. The cross section can also be trapezoidal. Advantageously, the poles of one flange are insulated from the poles of the other flange. On FIG. 3, an insulator 28 is inserted between the edges 22 of the poles 15. Insulator 28 allows better detection of pole changes by sensor 16. The insulator is for example air or a non-magnetic material such as plastic or copper.

FIG. 4 shows graphically detection of alternation of poles 15 of magnet 14 by the sensor 16 in device 10. FIG. 4 shows a side view of magnet 14 according to FIG. 3. The two flanges 24 and 26, respectively polarized South and North, have poles 15 extending therebetween. The poles have the polarity of their respective flange. Sensor 16 is shown at different relative positions A, B, C with respect to magnet 14, as a function of movement along axis 13 of drive shaft 12. The magnet 14 or sensor 16 is driven by the shaft. In the example described, magnet 14 is driven by the shaft 12 and the sensor 16 is inside casing 11.

The positions A and C correspond to extreme advance or retraction positions of shaft 12 along axis 13 inside casing 11. Position B is an intermediate position of shaft 12. The lines referenced 30a, 30b, 30c show the poles 15 of magnet 14 passing in front of sensor 16 during rotation of shaft 12 about axis 13. The positions A, B, C show the mobility of the shaft along axis 13 (arrow 18 on FIG. 1) and the lines 30a, 30b, 30c show the rotation of shaft 12 about axis 13 (arrow 17 on FIG. 1).

FIG. 4 also shows detection by sensor 16 of the poles 15 that present themselves to sensor 16. The signal is for example a square wave indicating a “0” state when a North pole is detected and which indicates a “1” state when the South pole is detected. The signals Sa, Sb, Sc represent detection by sensor 16 of the alternation of the poles which are presented to it depending on the various positions of shaft 12. Depending on the relative position A, B,C, of sensor 16 with respect to magnet 14, the time taken for North and South poles to pass in front of sensor 16 is different

At position A, sensor 16 is close to South polarized flange 24. In this position, and in view of the convergence of the pole edges 22, sensor 16 is at a position corresponding to the base of the triangular section South poles and the peaks of the reverse-triangular-section North poles. Thus, the time that the South poles take to pass in front of sensor 16 is greater than that taken by the North poles to pass in front of sensor 16. This is reflected by a signal Sa indicating a state which is principally a “1” interrupted by brief switching to a “0” state.

At position B, the sensor is about half way between South polarized flange 24 and North polarized flange 26. Sensor 16 is at half the height of the North and South poles. Consequently, the time the North and South poles take to pass in front of sensor 16 is substantially the same. This is reflected by a signal Sb indicating “0” and “1” states of similar durations.

At position C, sensor 16 is close to North polarized flange 26. In this position, and in view of the convergence of the pole edges 22, the sensor 16 is at a position corresponding to the base of the triangular section North poles and to the peaks of the reverse-triangular-section South poles. Thus, the South poles take less time to pass in front of sensor 16 than do the North poles. This is reflected by a signal Sc indicating a state which is principally a “0” interrupted by brief switch-overs to the “1” state.

The square waves Sa, Sb, Sc differ reflecting a different detection by sensor 16 of the poles depending on the relative position of magnet 14 and sensor 16. The repetitive succession of poles in front of the sensor does not take place in the same manner as a function of the relative position of sensor and magnet. Magnet 14 presents to sensor 16, an alternation of poles which differs depending on the relative positions A, B, C. Depending on the part that one or the other of the poles plays in the detection, it is possible to determine, simply, the position of shaft 12 along axis 13. The device can be applied in the case of a motor and reduction gear incorporating such a device 10. The motor and reduction gear can further include an output shaft 32 (FIG. 1) driven by drive shaft 12. For this, drive shaft 12 is for example provided with a worm gear 34 driving a pinion 36 carrying output shaft 32. This can typically be a window glass regulator motor and speed reduction gear. The window glass regulator also includes a drum for winding a cable, or a mechanical arm. The output shaft drives the winding drum or the arm.

Device 10 makes it possible to determine the torque applied to output shaft 32 by determining axial movement of drive shaft 12. In effect, depending on the torque applied to the output shaft, the resistance of pinion 36 to be driven by shaft 12 is larger or smaller. This is reflected by an axial movement of drive shaft 12 in casing 11 the position of which along axis 13 is determined by the device 10. The device 10 provides a simple and rapid way of determining the output torque from the motor and speed reduction gear.

The motor output torque is reflected by an axial force on the drive shaft axis. The greater this torque, the greater this axial force and the greater the movement of the drive shaft.

Device 10 can for example be implemented in a window glass regulator motor and reduction gear so as to detect the trapping of an object by the window glass. When the upward movement of a window glass is hindered by an object, the torque applied to the window glass regulator output shaft increases. This is reflected by the drive shaft moving along its axis of rotation. Device 10 makes it possible to measure this displacement and to issue an instruction to stop drive of the window glass. This is also applicable to detecting end-of-travel of the window glass.

FIG. 5 shows another embodiment of magnet 14. In this embodiment, the magnet has flanges 24,26 and poles 15 enveloping a magnetic core 38, poles 15 and flanges 24,26 are of magnetizable material; magnetic core 38 allows magnetization of the flanges and poles. The presence of core 38 allows durable magnetization of the flange and poles. Each flange 24,26 can be machined directly with the poles 15 which extend from the flange along axis 13. Each flange is of a one-piece construction with the poles which extend along axis 13, from the flanges. This allows the magnet to be produced with an annular structure more simply and less expensively. In particular, this avoids having to machine a magnetised material or assemble magnets around a ring, which is lengthy and expensive.

Each flange provided with its poles forms a half-envelope; magnetic core 38 is thus enveloped by two half-envelopes which mutually interfit. FIG. 6 shows one half of the envelope; FIG. 6 being a top view of FIG. 5. There can be seen flange 24 with the poles 15 distributed over its circumference. The flanges and poles give the magnet an annular structure, with a passage 48 for a the drive shaft. The poles 15 thus define a housing for core 38. The poles can be regularly distributed about the circumference of flange 24; the poles 15 are angularly spaced allowing the poles 15 associated with the other flange 26 to be interleaved therewith. The other half-envelope is reversed on the half-envelope of FIG. 6, the poles of each half-envelope alternating and the flanges resting on core 38. The core has preferably a North pole and South pole along axis 13. Thus, the flanges 24,26 each rest on one pole of core 38, each flange acquiring the polarity of the pole with which it is in contact. Each flange transfers the polarity it has acquired to the poles 15, each of the half-envelopes thus being polarized differently. In this way, two magnetizable half-envelopes are produced, tooling being facilitated by using material which is more rigid than that of the core.

The half-envelopes can be insulated from each other by an insulator 28. This allows the sensor to provide a sharper detection of pole alternation. It avoids spurious signal zones at the transition between poles.

FIG. 7 shows detail of magnet 14. This figure shows two successive poles (or polar masses) 154 and 156 respectively linked to flanges 24 and 26. Pole 154 is for example a South pole and pole 156 a North pole. The space between the poles 154 and 156 can be occupied by the insulator 28. Sensor 16 detects the alternations of N and S poles. The poles 154 and 156 are connected at their base 40 to the flanges 24 and 26. The poles 154,156 have an inclined plane 42 extending from an edge 46 down to a tenon or projecting rectangular part 44. Tenon 44 allows the sensor to detect pole alternation more effectively. The tenon has a width transversely to axis 13 allowing sensor 16 to detect the presence of a South pole 154 between two North poles 156, while magnet 14 is being driven in rotation at high speed. Depending on movement of the drive shaft along axis 13, the sensor is nearer or farther from one or the other of the bases 40. Thus, the poles 15 have edges 22 facing each other in the form of a broken line the ends of which (tenon 44 and edge 46) extend parallel to axis 13.

The line 30 corresponds to sensor 16 detecting the alternation of poles it is presented with; the line corresponds to one of the lines 30a, 30b, 30c of FIG. 4, line 30 varying in position along axis 13 depending on the load applied to the drive shaft. For example, the position shown corresponds to the relative position of the drive shaft with respect to sensor 16, when the drive shaft is turning freely with no-load. When a load is coupled to the drive shaft, the position thereof along axis 13 changes, sensor 16 being for example at a higher position along the axis 13 in FIG. 7.

In the rest position, it is preferred to position the sensor offset along axis 13 in the direction of one of the bases 40 of pole 154 or 156, so that, under load, sensor 16 will shift towards the half-height position of the poles. In particular, offsetting of the position of sensor 16 towards the half-height of poles 154,156 is brought about when the window glass is being driven to raise it. Thus, when the window glass is being raised, line 30 is no longer at half the height of the poles 154, 156. Line 30 runs along inclined plane 42, for example along plane 42 of pole 154. When the window glass is being raised, the line oscillates along the plane 42 of pole 154. Along plane 42, sensor 16 detects shaft movements better; in effect, along plane 42 and regardless of position along axis 13, the sensor 16 will detect, for a greater or lesser period of time, pole 54 which reflects shaft movement and possible entrapment by the window glass. This is due to a width for pole 154 or 156 transversally to axis 13 which varies along inclined plane 42, which is not the case at the height of edge 46 or tenon 44. This allows more accurate detection of entrapment of an object such as a finger by the window glass.

Sensor 16 can be a bistable (latched). It changes from the “1” state in front of a South pole (for example) and should change over in front of a North pole to switch to the “0” state. Sensor 16 is placed on line 30. Line 30 moves along plane 42 depending on the motor output torque. Resulting from the shape of the polar masses 156 and 154, the time t1 for the North pole to pass and the time t2 for the South pole to pass in front of the sensor vary depending on the position of line 30 on plane 42. With the help of a microcontroller, the ratio t1/t2 or t1/(t2+t1) or t2/(t1+t2) can be calculated. This is the duty cycle of the signal generated by the Hall effect sensor 16. The duty cycle varies as a function of the position of curve 30 on plane 42. Now, as the position of curve 30 depends on the motor output torque, the duty cycle of the signal from sensor 16 depends on the motor output torque. Consequently, if an obstacle were to appear while the window glass is being raised, there will be a variation in torque which is reflected by a variation in signal duty cycle.

Obviously, this invention is' not limited to the embodiments described by way of example. Thus, the multi-pole magnet could be replaced by a ring with surfaces having differing reflecting characteristics and the sensor employed could be an optical sensor. It could also be envisaged for the magnet to include empty spaces, the sensor detecting either the presence of a pole or the absence of a pole.

What is claimed is:

1. A device for determining movement of a drive shaft rotatable about an axis of rotation and moveable along the axis of rotation, the device comprising:
a multi-pole magnet having North and South poles; and
a sensor, and one of said sensor and said multi-pole magnet is driven by the drive shaft, wherein said multi-pole magnet presents to said sensor said North and South poles which alternate as a function of both a relative angular position and a relative longitudinal position of said sensor and said multi-pole magnet, wherein said North and South poles are made of a magnetizable material.

2. The device according to claim 1, wherein said North and South each poles each have inclined edges, and extremities of said North and South poles extend parallel to the axis of rotation of the drive shaft.

3. The device according to claim 2, wherein said multi-pole magnet is a ring having flanges, and wherein said ring is rotated by the drive shaft, and said North and South poles envelop a magnetic core.

4. The device according to claim 3, wherein said North and South poles have a triangular cross section.

5. The device according to claim 1, wherein said sensor is a Hall effect sensor.

6. The device according to one claim 1, further comprising a casing, wherein the drive shaft and said sensor are located in said casings.

7. A motor and speed reduction gear comprising:
a drive shaft rotatable about an axis of rotation and movable along said axis of rotation; and
a device for determining movement of said drive shaft comprising:
a multi-pole magnet having North and South poles; and
a sensor, wherein one of said sensor and said multi-pole magnet is driven by said drive shaft, wherein said multi-pole magnet presents to said sensor said North and South poles which alternate as a function of both a relative angular position and a relative longitudinal position of said sensor and said mulit-pole magnet, and said North and South poles are made of a magnetizable material.

8. The motor and speed reduction gear according to claim 7, further comprising an output shaft driven by said drive shaft.

9. A window glass regulator comprising:
a cable winding drum;
a drive shaft rotatable about an axis of rotation and movable along said axis of rotation;
an output shaft driven by said drive shaft, wherein said output shaft drives said cable winding drum; and
a motor and speed reduction gear including a device for determining movement of said drive shaft, said device comprising:
a multi-pole magnet having North and South poles; and
a sensor, and one of said sensor and said multi-pole magnet is driven by said drive shaft, wherein said multi-pole magnet presents to said sensor said North and South poles which alternate as a function of both a relative angular position and a relative longitudinal position of said sensor and said mulit-pole magnet, and said North and South poles are made of a magnetizable material.

10. A magnet comprising:
a plurality of poles that alternate during rotation about an axis of rotation as a function of a position of said magnet along said axis of rotation and with respect to a plane perpendicular to said axis of rotation.

11. The magnet according to claim 10, wherein said plurality of poles include convergent edges.

12. The magnet according to claim 10 further comprising:
a first coaxial flange including two first poles; and
a second coaxial flange including two second poles, wherein said two first poles extend toward said second coaxial flange and said two second poles extend toward said first coaxial flange, wherein each of said two first poles is interleaved between said two second poles and each of said two second poles is interleaved between said two first poles.

13. The magnet according to claim 12, wherein said first pole is integrated with said first coaxial flange and said second pole is integrated with said second coaxial flange.

14. The magnet according to claim 12, wherein said first coaxial flange, said first pole, said second coaxial flange, and said second pole envelop a magnetic core.

15. The magnet according to claim 12, wherein said first coaxial flange, said first pole, said second coaxial flange, and said second pole are made of a magnetizable material.
